(19) United States
(12) Patent Application Publication
(10) Pub. No.: US 2005/0279645 A1
(43) Pub. Date: Dec. 22, 2005

(54) Process for electrolytic derusting of ferrous materials using natural seawater

(75) Inventors: Nerur Sankaranayan Rengaswamy, Karaikudi (IN); Sironmani Palraj, Karaikudi (IN); Gopalan Subramanian, Karaikudi (IN); Thirupathisaram Muthukrishna Balasubramanian, Karaikudi (IN)

Correspondence Address: LADAS & PARRY, 26 WEST 61ST STREET, NEW YORK, NY, 10023, US

(73) Assignee: COUNCIL OF SCIENTIFIC AND INDUSTRIAL RESEARCH

(21) Appl. No.: 11/158,278

(22) Filed: Jun. 21, 2005

Related U.S. Application Data
(63) Continuation of application No. 10/463,229, filed on Jun. 17, 2003, now abandoned.
Application No. 10/463,229 is a continuation of application No. 09/725,638, filed on Nov. 29, 2000, now abandoned.

(51) Int. Cl. B23H 3/08

(52) U.S. Cl. 205/674

(57) ABSTRACT

This invention relates to a process for the derusting or removal of corrosion products form ferrous metal substrate by electrochemical treatment.

### FIELD OF THE INVENTION

The present invention relates to a process for the electrolytic derusting of ferrous process for the electrolytic derusting of intricate ferrous material surfaces using natural seawater.

### BACKGROUND OF THE INVENTION

Several methods are known in the prior art for the cleaning/derusting/removing corrosion products from the surfaces of ferrous based materials by surface treatment Prior art processes are based on chemical methods and on electrochemical treatment.

Amongst the chemical processes known in the art, it is known to treat steel whether plain, twisted, or pre-stressed to remove corrosion products (Hudson, J. C., Iron Steel Inst. Special Rep, Corr. Cttee., 1935, 3, 60). The above process involves immersion of the steel components in 20% sulphurio acid solution containing an inhibitor (quinoline) for about 2 hours at 10° C. Hudson J. C. also discloses the immersion of steel components in 20% sulphuric acid for 1 hour at 60° C. using 0.05 % di orthotolythiourea as an inhibitor (Hudson J. C., Iron steel Inst. Special Rep. Corr. Cttee. 1936, 4, 100). However, the loss of steel in this latter process was 13 gm/sq.m in one hour at 60° C.

Another prior art process discloses the immersion of steel in Clarke's solution of HCl (100 parts), antimony trioxide (2 parts) and stannous chloride (5 pans) (Hudson J. C., In steel Inst. Special Rep. Corr. Cttee., 1935, 3, 60; and Clarke S. G., Trans. Electrochem. Soc., 1936, 69, 131). The solution may be used at room temperature with vigorous stirring and immersion for a duration of 25 minutes has been found to be adequate.

Hatfield et al teach the immersion of steel in a slightly ammoniacal solution of ammonium citrate (20%) at 75 to 80° C. for about 20 minutes, using 30 litres of solution per. sq. m of metal surface (Hatfield, W. H., and Shirley, H. T., Iron Steel Inst., Special Rep. Corr. Cttee., 1936, 4, 174). The loss of weight of the blank specimen was less than 3 gm/sq. m.

Cournot et al teach another process wherein the specimen is immersed in a vigorously boiling solution of 20% NaOH, fllowed by subsequent addition of Zn dust at the rate of 30 gm/litre (Cournot, J and Chaussain M., Rev. Met., 1934, 31, 487 and also Grard, C., La Corrosion en Metallurgie, Paris, Berger Lerrault, 1936) The pascent H₂ from the dissoluton of the Zn in the a reduces the corrosion product to the ferrous condition and renders it it less adherent, enabling removal by intermittent brushing. An immersion time of about 5 minutes is usually sufficient.

Alexander H. L. discloses a process using a sodium hydride bath (Alexander H. L., Iron Steel Eng., 24, 44-51 (1947)). The bath consists of molten caustic (399° C.) containing from about 0.75 to 2.5% NaH. The specimen is immersed in the bath up to 15 minutes and then water quenched.

Another chemical process for the treatment of stainless steel known in the art comprises dipping stainless steel in 100 ml nitric acid (HNO₃, Sp. gr. 1.42) with water to make it 1 litre at a temperature of 60° C. for 20 minutes. Anotber process comprises dipping the specimen in a solution of ammonium citrate (150 g) in water to make it 1 litre at a temperature of 70° C. for a time period ranging between 10 to 60 minutes (Annual Book of ASTM Standards, part 10, Metals—Physical, Mechanical, Corrosion Testlog, 1980, 783).

Hudson J. C. also teaches an electrochemical treatment of steel components such as mild steel, carbon steel, cold rolled steel, and reinforcement rods whether plain, twisted, or pre-stressed (Hudson J. C., Iron Steel Inst., Special Rep. Corr. Cttee., 1935, 3, 60). The process disclosed comprises electrochemical treatment of the specimen in saturated citric acid solution for a relatively long time of about 3 hours at a temperature below 60° C., preferably below 20° C. to avoid appreciable dissolution of the metal (see also Sutton H., Iron Steel Inst., Special Rep. Corr Cttee, 1931, 1, 207)

Sutton H., also teaches the cleaning of the specimen by using Willstrop's NaCN or KCN solutions (5 to 10%) at 20° C. to give a metal loss of less than 1 gm /sq. m. The immersion time is about three hours at 1.5 A/sq, dm to obtain consistency in the results (Sutton H., Iron Steel Inst. Special Rep. Corr. Cttee., 1931, 1, 207; also Schroeder W. A. W., Iron Steel Inst. Special Rep. Corr. Cttee., 1934, 2, 222).

It is also known in the art to electrochemically treat the specimen with a mixture of 60% NaOH and 40% of Na₂CO₃ as anode at 400° C. in a monel beaker. A current denisity is abut 15 A/sq. dm is applied for about 5 minutes and the metal loss is abut 2 gm/sq m (Wachter A. and Treseder R. S., Chem. Eng Progcss, 1947, 43, 315).

Another prior art process applicable for both steels and stainless steels comprises scrubbing of the specimen to remove the loosely attached corrosion products and then electrolysing the specimen in a solution comprising H₂SO₄ (Sp, gr. 184, 28 ml) with water to make 1 litre, and 2 ml of organic inhibitor. The temperature is about 75° C. and the time taken is about 3 minutes. The anode is C or Pb and the cathode is the test specimen. The current density is about 20 A/.sq. dm. The organic inhibitor is selected from diorthotolyl thiorca and quinoline ethiodide.

Hitherto known prior art processes for derusting/removal of corrosion products as a means of surface preparation of ferrous materials are harmful to the materials due to base metal attack or to the environment due to liberation of pollutants. The prior art processes are also hazardous to the personnel operating due to the evolution of by-products and gases during the process. Prior art processes are also more expensive due to higher energy consumption, and loss of electrolyte during operation.

It is therefore imperative to develop a process for derusting/removal of corrosion products as a means of surface preparation of ferrous materials prior to processes of surface treatment by phosphating, nitriding, chromating, eletropolishing, electroplating, etc. that is environmentally friendly, user friendly, and also safe and economical and obviates the disadvantages in the prior art processes.

### OBJECTS OF THE INVENTION

The main object of the invention is to provide a process for the derusting/removal of corrosion products of ferrous materials as a means for surface preparation prior to surface treatment, which is energy efficient.

It is another object of the invention to provide a process for the derusting/removal of corrosion products of ferrous materials as a means for surface preparation prior to surface treatment, which is environmentally friendly.

It is yet another object of the invention to provide a process for the derusting/removal of corrosion products of ferrous materials as a means for surface preparation prior to surface treatment, which is user friendly and safe.

It is a further object of the invention to provide a process for the derusting/removal of corrosion products of ferrous materials as a means for surface preparation prior to surface treatment, which is material friendly.

It is another object of the invention to provide a process for the derusting/removal of corrosion products of ferrous materials as a means for surface preparation prior to surface treatment, which enables recycling of the electrolyte.

### SUMMARY OF THE INVENTION

Accordingly, the present invention provides a process for the derusting/removal of corrosion products from a ferrous material substrate, said process comprising electrochomical treatment of the substrate in natural seawater as electrolyte under an optimum current density in the range of 6 to 8 A/sq. dm using an inert anode of stainless steel material.

In one embodiment of the invention, the stainless steel anode is made of—304 stainless steel.

In one embodiment of the invention the ferrous metal substrate is selected from mild steel, cold rolled steel, carbon steel, stainless steels, reinforcement rods whether plain, twisted or pre-stressed, and intricate metal components such as pins, needless, nails, bolts, hooks, nuts, fasteners, clips and the like.

In one embodiment of the invention, the process is carried out at a temperature ranging from 28° C. to 40° C.

In another embodiment of the invention, the process is carried out at electrolyte pH in the range of 6 to 9.

In a further embodiment of the invention, the pH of electrolyte seawater is in the range of 7.9 to 8.2.

In another embodiment of the invention, there is minimal variation in the pH of the electrolyte during the process.

In a further embodiment of the invention, the anode comprises a more noble metal than the cathode specimen.

In a further embodiment of the process, the electrolyte is recycled on completion of electrolysis after suitably changing the solution chemistry.

### DETAILED DESCRIPTION OF THE INVENTION

Ferrous materials of different natures such as mild steel, carbon steel, cold rolled steel, steels used in structural engineering such as reinforcement rods, whether plain, twisted of pre-stressed were used as specimens for an extensive study for derusting/removal of corrosion products. The aim of the study is to develop an economical, environmentally friendly, user friendly, safe, and efficient process for the surface preparation of ferrous materials prior to surface treatment of the materials by phosphating, nitriding, chromating, electroplating, electropolishing etc.

The electrolyte chosen was natural seawater with a pH normally in the range of 7.9 to 8.2. The abundance of the electrolyte renders the process more economical than prior art processes relating to the derusting/removal of corrosion products from ferrous material (including intricate components and inaccessible parts) as a means of surface preparation prior to surface treatment of the material. The electrolyte is the major constituent of the process. The disposal of the seawater does not pose a problem, since there is very little variation in the pH thereof. Also, the eleotrolyte can be reused after making suitable changes in the solution chemistry.

Seawater drawn from the sea is filtered to remove dust, dirt and turbidity. The clear natural seawater is transferred to a 25 litre capacity PVC tank The pH of the electrolyte is measured using a high precision digital pH meter prior to the commencement of the experiments. The pH of the electrolyte was observed to be in the range of 7.9 to 8.2. Prior to the immersion of the corroded steel specimen (test specimen) in the experimental tank, the surface of the specimen is cleaned with a bristle brush to remove loosely adherent corrosion products.

The test specimen is made the cathode and a more noble metal (stainless steel—304) than the test specimen is made the anode in order to complete the circuit. The bath is stirred with an electrical stirrer during the process of cathodic cleaning to maintain uniformity of the bath in terms of pH, temperature and chemical composition.

The cleaning operation is done on the test specimen over wide range of temperature from room temperature up to a critical temperature of 50° C. and pH ranging from 6 to 9. During these experiments, separate test specimens are used for each temperature range. The critical current density value is decided in terms of permutation and combination methods by conducting experiments at various current densities ranging from 2 Λ/sq. dm to the maximum threshold value. The duration of the cathodic treatment is also decided in terms of permutation and combination methods until a critical value is attained, wherein the cleaning operation has attained maximum or desired level, without much damage, to the base material.

The test specimen of each category (mild steel, carbon steel, cold rolled steel, structural engineering steels such as plain, twisted or pre-stressed reinforcement rods, need different experimental conditions of variability in the optimum current density requirement, critical temperature and duration of the cathodic treatment due to the varying nature of the surfaces of the materials and the thermodynamics of the nature of the products formed on the surfaces of the materials. In order to attain desirable level of cleaning. After the termination of cleaning operation in each category of material, the pH of the bath is measured. It is observed that no major shift, either acidic or alkaline, occurs in the pH value.

The efficiency of the process is decided comparing the extent of cleaning of the test specimen of both the present and conventional chemical cleaning processes—Clarke's solution. All the cleaned specimens are stored in dessicators after lacquering to avoid re-rusting. For handling bulk products such as bolts, nails, pins, needles, nuts, fasteners, clip and hooks, Barrel Plating unit is used over a wide range of experimental conditions and parametric variability as detailed above.

The following examples are by way of illustration only and should not be construed as limiting the scope of invention in any manner.

### EXAMPLE 1

### Electrolytic Derusting of Mild Steel

The salient feature of the electricity derusting of mild steel are detailed below:

| | |
|---|---|
| Duration of the Cleaning | 35 Minutes |
| Treatment of Cleaning | both cathodic/anodic and cathodic |
| Opening condition | |
| i) Temperature | Room temperature (28° C.) |
| ii) Current density | 8 A/sq. dm |
| iii) pII of th bath | 8.2 |
| iv) Electrolyte | natural seawater |

The efficiency of cleaning is achieved (as a means of conducting experiments at different temperatures, current densities, pH, duration of cleaning and type of treatment) during the above operating conditions ranges from 60 to 100% in comparison to the conventional acid pickling (Clarke's solution). The current density (8 Λ/sq. dm), temperature (28° C.), pH of the bath (8.2, natural seawater pH) and duration of cleaning [30 minutes—both the processes i) cathodic (25 minutes)/anodic (5 minutes) and; ii) cathodic (30 minutes)] are recorded, wherein the, maximum extent of cleaning (100%) are achieved. Of the two methods, cathodic/anodic and cathodic, the cathodic treatment is found to be more effective and the base metal loss due to this electrolytic cleaning is negligible compared to conventional methods of pickling. The extent of liberation of pollutants (gases) is also negligible compared to conventional methods of pickling. The cost of operation of this process is nearly 100 times less than the conventional process of cleaning. Thus this process is more material friendly, economical, environmentally friendly and user friendly (safe).
Mechanism of Process

In the present process of electrolytic cleaning of the corroded ferrous material surfaces, the test specimen is treated as a cathode by using a more noble material (Stainless steel—304) as the anode. During the cathodic cleaning of the test specimen in natural seawater, the release/liberation of two volumes of H₂ (bubbles) at the interface of the cathode metal surface/rust tends to dislodge the rust physically. To overcome H₂ occlusion on the test specimen, anodic, cleaning is effected for a few seconds at regular intervals, without causing much dissolution of the base metal. This is also confirmed by experiments with control specimens. Control specimens are also tested for the same duration of anodic treatment, and the metal loss is found to be insignificant and that also takes into account, blank correction.

### EXAMPLE 2

### Electrolytic Derusting of Cold Rolled Steel

The salient features of the electrolyte derusting of cold rolled steel are detailed below:

| | |
|---|---|
| Duration of cleaning | 18 minutes |
| Treatment of cleaning | Both cathodic/anodic and cathodic |
| Operating conditions | |
| i) Temperature | Room Temperature (28° C.) |
| ii) Current density | 8 A/sq. dm |
| iii) pH of the bath | 6.0 (pII is adjusted to 6.0 by adding |
| | drops of HCl in seawater) |
| iv) Electrolyte | natural sea water |

The efficiency of cleaning is achieved (as a means of conducting experiments at different temperatures, current densities, pH, duration of cleaning and type of treatment) during the above operating ranges from 70 to 100% in comparison to the conventional acid pickling (Clarke's solution). The current density (8 A/sq.dm), temperature (28° C.), pH (6.0) and duration of cleaning [18 minutes—both the process i) cathodic (15 minutes)/anodic (3 minutes ) and; ii) cathodic (18 minutes )] are recorded, wherein the maximum extent of cleaning (100%) are achieved. Of the two methods, cathodic/anodic and cathodic, the cathodic treatment is found to be more effective and the base metal loss due to this electrolytic cleaning is negligible compared to conventional methods of pickling. The extent of liberation of pollutants (gases) is also negligible compared to conventional methods of pickling. The cost of operation of this process is nearly 100 times less than the conventional processes of cleaning. Thus this process is more material friendly, economical, environmentally friendly and user friendly (safe).

### EXAMPLE 3

### Electrolytic Derusting of Reinforcement Plain Steel Rod

The salient features of the electrolytic derusting of reinforcement plain steel rod are detailed below:

| | |
|---|---|
| Duration of cleaning | 35 minutes |
| Treatment of cleaning | Both cathodic/anodic and cathodic |
| Operating conditions | |
| i) Temperature | 40° C. |
| ii) Current density | 8 A/sq. dm |
| iii) pH of the bath | 8.2 |
| iv) Electrolyte | natural seawater |

The efficiency of cleaning is achieved (as a means conducting experiments at different temperatures, current densities, pH, duration of cleaning and type of treatment) during the above operating conditions ranges from 70 to 100% in comparison to the conventional acid pickling (Clarke's solution). The current density (8 A/sq. dm), temperature (40° C.). pH (8.2) and duration of [35 minutes both the processes i) Cathodic (28 minutes)/anodic (7 minutes) and; ii) Cathodic (35 minutes)] are recorded, wherein the maximum extent of cleaning (100%) are achieved. Of the two methods, cathodic/anodic and cathodic, the cathodic treatment is found to be more effective and the base metal loss due to this electrolytic cleaning is negligible compared to conventional methods of pickling. The extent of liberation of pollutants (gases) is also negligible compared to conventional methods of pickling. The cost of operation of this process is nearly 100 times less than the conventional process of cleaning. Thus this process is more material friendly, economical, environmentally friendly and user friendly (safe).

### EXAMPLE 4

### Electrolytic Derusting of Reinforcement Twisted Steel Rod

The salient features of the electrolytic derusting of reinforcement twisted steel rod are detailed below:

| | |
|---|---|
| Duratian of cleaning | 36 minutes |
| Treatment of cleaning | Both cathodic/anodic and cathodic |
| Opearating conditions | |
| i) Temperature | Room temperature (28° C.) |
| ii) Current density | 8 A/sq. dm |
| iii) pH of the bath | 6.0 (pH is adjusted to 6.0 by adding drops of HCl |
| | in seawater) |
| iv) Electrolyte | natural seawater |

The efficiency of cleaning is achieved (as a means of conducting experiments at different temperatures, current densities, pH, duration of cleaning and type of treatment) during the above operating conditions ranges from 34 to 100% in comparison to the conventional acid pickling (Clarke's solution) The current density (8 A/sq.dm), temperature (28° C. room temperature), and duration of cleaning [36 minutes—both the process i) cathodic (27 minutes)/anodic (9 minutes) and; ii) cathodic (36 minutes) are recorded, wherein the maximum extent of cleaning (100%) are achieved. Of the two methods, cathodic/anodic and cathodic, the cathodic treatment is found to be more effective and the base metal loss due to this electrolytic cleaning is negligible compared to conventional methods of pickling. The extent of liberation of pollutants (gases) is also negligible compared to conventional methods of pickling. The cost of operation of this process is nearly 100 times less than the conventional processes of cleaning. Thus this process is more material friendly, economical environmentally friendly and user friendly (safe).

### EXAMPLE 5

### Electrolytic Derusting of Pre-stressed Steel Rod

The salient features of the electrolytic derusting of pre-stressed steel rod are detailed given below:

| | |
|---|---|
| Duration of cleaning | 35 minutes |
| Treatment of cleaning | Cathodic |
| Operating conditions | |
| i) Temperature | 40° C. |
| ii) Current density | 8 A/sq. dm |
| iii) pH of the bath | 8.2 |
| iv) Electrolyte | natural seawater |

The efficiency of cleaning is achieved (as a means of conducting experiments at different temperatures, current densities, pH, duration of cleaning and type of treatment) during the above operating conditions ranges from 50 to 100% in comparison to the conventional acid pickling (Clarke's solution). The current density (8 A/sq. dm), temperature (40° C.), pH (8.2, natural seawater pH, and duration of cleaning (35 minutes—cathodic) are recorded, wherein the maximum extent of cleaning are achieved. The cathodic treatment is found to be effective and the base metal loss due to this electrolytic cleaning is negligible compared to conventional methods of pickling. The extent of liberation of pollutants (gases) is also negligible compared to conventional methods of pickling. The cost of operation of this process is nearly 100 times less than the conventional processes of cleaning. Thus this process is more material friendly, economical, environmentally friendly and user friendly (safe)

### EXAMPLE 6

### Electrolytic Derusting of Stainless Steel—304

The salient features of the electrolytic derusting of stainless steel—304 are detailed below:

| | |
|---|---|
| Duration of cleaning | 12 minutes |
| Treatment of cleaning | cathodic |
| Operation conditions | |
| i) Temperature | Room temperature (28° C.) |
| ii) Current density | 6 A/sq. dm |
| iii) pH of the bath | 8.2 |
| iv) Electrolyte | natural seawater |

The efficiency of cleaning is achieved (as a means of conducting experiment at different temperatures, current densities, pH, duration of cleaning and type of treatment) during the above operating conditions ranges from 80 tp 100% in comparison to the conventional acid pickling (10% HNO₃ at 60° C.). The current density (6 A/sq. dm), temperature (28° C.), pH (8.2) and duration of cleaning (12 minutes—cathodic) are recorded, wherein maximum extent of cleaning are achieved. The cathodic treatment is found to be effective and the bass metal loss is negligible. The base metal loss due to this process is negligible compared to the conventional methods of pickling. The extent of liberation of pollutants (gases) is also negligible compared to conventional methods of pickling. The cost of operation of this process is nearly 100 times less than the conventional process of cleaning. Thus this process is more material friendly, economical, environmentally friendly and user friendly (safe).

### EXAMPLE 7

### Electrolytic Derusting of Stainless Steel—430

The salient features of the electrolytic derusting of stainless steel—430 are detailed below:

| | |
|---|---|
| Duration of cleaning | 12 minutes |
| Treatment of cleaning | cathodic |
| Operation conditions | |
| i) Temperature | Room temperature (28° C.) |
| ii) Current density | 4 A/sq. dm |
| iii) pH of the bath | 8.2 |
| iv) Electrolyte | natural seawater |

The efficiency of cleaning is achieved (as a means of conducting experiment at different temperatures, current densities, pH, duration of cleaning and type of treatment) during the above operating conditions ranges from 80 to 100% in conmparison to the conventional acid pickling (10% HNO₃ at 60° C.). The current density (4 A/sq. dm), temperature (28° C.), pH (8.2) and duration or cleaning (12 minutes—cathodic) are recorded, wherein the maximum extent of cleaning achieved. The cathodic treatment is found to he more effective and the base metal loss due to this electrolytic cleaning is negligible. The base metal loss due to this process is also found to be negligible compared to the conventional methods of pickling. The extent of liberation of pollutants (gases) is also negligible compared to conventional methods of pickling. The cost of operation of this process is nearly 100 times less than the conventional process of cleaning. Thus this process is more material friendly, economical, environmentally friendly and user friendly (safe).

### ADVANTAGES OF THE INVENTION

1. The process as a whole is environmentally friendly, as no major pollutant is involved during operation and even most of the gaseous products liberated during the process are utilised in the cleaning process, unlike conventional methods, both chemical and electrolytic cleaning.
2. The process as a whole is material friendly as the base metal loss due to this process is found to be negligible compared to conventional methods of chemical and electrolytic cleaning.
3. The process of the present invention is user friendly as no hazardous gaseous product or any other by-product is produced during the cleaning operation, unlike conventional methods of chemical or electrolytic cleaning.
4. The process is also cost effective as the energy consumption is low and the total operational cost is at least 75-90 times less than conventional methods. The process as a whole is viable commercially and the cost effective particularly with regard to the bulk handling of tiny and intricate ferrous components such as fasteners, clips, pins, needles, hooks, nuts, bolts, with Barrel plating unit rather than the hitherto known methods.
5. The process is also cost effective since the electrolyte used is seawater that is abundantly available and is recyclable even after several operations of cleaning.

1. A process for the derusting or removal of corrosion products from a ferrous material substrate, said process comprising electrochemical treatment of a substrate in natural seawater as electrolyte under an optimum current density in the range of 6 to 8 A/sq.dm. using a stainless steel anode.

2. A process as claimed in claim 1, wherein the anode is a —304 stainless steel anode.

3. A process as claimed in claim 1, wherein the ferrous metal substrate is selected from the group consisting of mild steel, cold rolled steel, carbon steel, stainless steels, reinforcement rods whether plain, twisted or pre-stressed, and intricate metal components such as pins, needles, nails, bolts, hooks, nuts, fasteners and clips.

4. A process as claimed in claim 1, wherein the process is carried out at a temperature ranging from 28° C. to 50° C.

5. The process as claimed in claim 1, wherein the pH of the natural seawater is 7.9 to 8.2.

6. A process as claimed in claim 1, wherein there is minimal variation in the pH of the electrolyte during the process.

7. (canceled)

8. The process as claimed in claim 1, wherein the electrolyte is recycled.

9. The process as claimed in claim 5, wherein the pH of natural seawater is adjusted to 6 to 9.
